(19) United States
(12) Patent Application Publication
(10) Pub. No.: US 2011/0045174 A1
(43) Pub. Date: Feb. 24, 2011

(54) SOFT MAGNETIC MATERIAL AND DUST CORE

(75) Inventors: Toru Maeda, Itami-Shi (JP); Naoto Igarashi, Itami-shi (JP); Haruhisa Toyoda, Itami-shi (JP)

Correspondence Address: OSHA LIANG L.L.P., TWO HOUSTON CENTER, 909 FANNIN, SUITE 3500, HOUSTON, TX, 77010, US

(73) Assignee: SUMITOMO ELECTRIC INDUSTRIES, LTD., Osaka-Shi (JP)

(21) Appl. No.: 12/917,243

(22) Filed: Nov. 1, 2010

Related U.S. Application Data
(62) Division of application No. 11/911,657, filed on Oct. 15, 2007.

(30) Foreign Application Priority Data
Apr. 15, 2005 (JP) 2005-118581

(51) Int. Cl. B05D 5/00

(52) U.S. Cl. 427/127

(57) ABSTRACT

A method of producing a soft magnetic material is disclosed, wherein the method includes forming a plurality of metal magnetic particles having a ratio of a maximum diameter to an equivalent circle diameter greater than 1.0 and at most 1.3, forming irregularities on a surface of each of the plurality of metal magnetic particles such that a specific surface area of each of the plurality of metal magnetic particles is at least 0.10 m²/g, and coating the plurality of metal magnetic particles with an insulating coating. The irregularities are formed by immersing the plurality of metal magnetic particles in an aqueous sulfuric acid.

### BACKGROUND OF THE INVENTION

1. Technical Field

The present invention relates to a soft magnetic material and a dust core, and in particular, to a soft magnetic material which includes a plurality of composite magnetic particles each composed of a metal magnetic particle and an insulating coating covering the metal magnetic particle, and a dust core including the soft magnetic material.

2. Background Art

In electrical devices including a solenoid valve, a motor, a power supply circuit, or the like, a dust core produced by molding a soft magnetic material under pressure is used. The soft magnetic material is composed of a plurality of composite magnetic particles, and each of the composite magnetic particles includes a metal magnetic particle and a glassy insulating coating covering the surface of the metal magnetic particle. Regarding a magnetic property of the soft magnetic material, it is desirable that an application of a low magnetic field can provide a high magnetic flux density, and the soft magnetic material can sensitively respond to a change in the magnetic field from the outside.

When the soft magnetic material is used in an AC magnetic field, an energy loss called “core loss” is generated. The core loss is represented by the sum of hysteresis loss and eddy-current loss. The term “hysteresis loss” means an energy loss caused by an energy required for changing the magnetic flux density of the soft magnetic material. Since hysteresis loss is proportional to the operating frequency, the hysteresis loss is dominant mainly in a low-frequency range. The term “eddy-current loss” used herein means an energy loss that is mainly caused by an eddy-current flowing between metal magnetic particles included in the soft magnetic material. Since eddy-current loss is proportional to the second power of the operating frequency, the eddy-current loss is dominant mainly in a high-frequency range. Recently, it has been desired for electrical devices to have reduced size, increased efficiency, and increased output. In order to meet these requirements, it is necessary to use electrical devices in a high-frequency range. For this reason, it has been desired for a dust core to have a particularly decreased eddy-current loss.

In the core loss of a soft magnetic material, in order to decrease hysteresis loss, by removing distortions and dislocations in metal magnetic particles so that magnetic walls can easily move, the coercive force Hc of the soft magnetic material may be decreased. On the other hand, in the core loss of the soft magnetic material, in order to decrease eddy-current loss, by reliably covering the metal magnetic particles with an insulating coating so as to ensure the insulating property between the metal magnetic particles, the electrical resistivity p of the soft magnetic material may be increased.

For example, Japanese Unexamined Patent Application Publication No. 2003-272911 (Patent Reference 1) discloses a technology related to a soft magnetic material. Patent Reference 1 discloses an iron-based powder (soft magnetic material) in which an insulating coating made of aluminum phosphate with high heat resistance is provided on the surface of a powder containing iron as a main component. In Patent Reference 1, a dust core is produced by the following method. First, an aqueous solution for forming an insulating coating containing a phosphate containing aluminum and a dichromate containing potassium or the like is jetted onto an iron powder. Subsequently, the iron powder on which the aqueous solution for forming an insulating coating is jetted is maintained at 300° C. for 30 minutes and then at 100° C. for 60 minutes. Accordingly, the insulating coating formed on the iron powder is dried to prepare an iron-based powder. Subsequently, the iron-based powder is molded under pressure, followed by a heat treatment. Thus, the dust core is produced.

### Patent Reference 1: Japanese Unexamined Patent Application Publication No. 2003-272911

### DISCLOSURE OF INVENTION

### Problems to be Solved by the Invention

As described above, since a dust core is produced by molding a soft magnetic material under pressure, high moldability is required for the soft magnetic material. However, an insulating coating provided on the surfaces of metal magnetic particles included in the soft magnetic material can be easily broken by pressure exerted during the pressure molding of the soft magnetic material. Consequently, particles of an iron-based powder included in the soft magnetic material can be easily electrically short-circuited, resulting in the following problems: Eddy-current loss itself is increased, and degradation of the insulating coating is accelerated in a heat treatment for removing distortions after molding, thereby easily increasing eddy-current loss. In contrast, in order to prevent the insulating coating from breaking, when the pressure exerted during molding is decreased, the density of the resulting dust core is decreased and satisfactory magnetic properties cannot be obtained. For this reason, the pressure exerted during molding cannot be decreased. Another means for suppressing the breakage of the insulating coating during pressure molding is the use of a spherical gas-atomized powder. However, such a gas-atomized powder is disadvantageous in that the powder is not suitable for increasing the density of a resulting compact and the strength of the compact is low.

Accordingly, it is an object of the present invention to provide a soft magnetic material in which eddy-current loss can be decreased and which is suitable for producing a dust core having a high strength, and a dust core combining a low eddy-current loss and a high strength.

### Means for Solving the Problems

A soft magnetic material of the present invention includes a plurality of composite magnetic particles each including a metal magnetic particle and an insulating coating covering the metal magnetic particle, wherein each of the plurality of composite magnetic particles has a ratio of the maximum diameter to the equivalent circle diameter of more than 1.0 and 1.3 or less and a specific surface area of 0.10 m²/g or more.

The present inventors have found that the cause of the breakage of an insulating coating during pressure molding of a soft magnetic material lies in projecting portions (portions each having a small radius of curvature) of a metal magnetic particle. More specifically, during pressure molding, stress concentrates particularly on the projecting portions of the metal magnetic particle, and the projecting portions become markedly deformed. In this case, the insulating coating cannot be markedly deformed together with the metal magnetic particle and becomes broken. Alternatively, the insulating coating becomes broken by being pushed by the tips of the projecting portions. Accordingly, in order to prevent the insulating coating from breaking during pressure molding, reducing the projecting portions of metal magnetic particles is effective.

Metal magnetic particles are divided into a base powder produced by a water-atomizing method (hereinafter referred to as “water-atomized powder”) and a base powder produced by a gas-atomizing method (hereinafter referred to as “gas-atomized powder”). Since a particle of a water-atomized powder has a large number of projecting portions, an insulating coating is easily broken during pressure molding. In contrast, a base powder produced by a gas-atomizing method (hereinafter referred to as “gas-atomized powder”) substantially has a spherical shape and has less projecting portions. Accordingly, it is believed that the breakage of the insulating coating during pressure molding may be prevented by using not a water-atomized powder but a gas-atomized powder as the metal magnetic particles. However, metal magnetic particles aggregate by engagement of irregularities that are present on the surfaces thereof. Therefore, metal magnetic particles of a gas-atomized powder, which substantially have a spherical shape, do not easily aggregate, thus markedly decreasing the strength of a resulting compact. As a result, a dust core produced using metal magnetic particles of a gas-atomized powder cannot be practically used. That is, the strength of a compact cannot be increased while eddy-current loss is decreased using either a known water-atomized powder or a known gas-atomized powder.

Consequently, the present inventors have found that the strength of a compact can be increased while eddy-current loss is decreased by using a soft magnetic material of the present invention including a plurality of composite magnetic particles each having a ratio of the maximum diameter to the equivalent circle diameter of more than 1.0 and 1.3 or less and a specific surface area of 0.10 m²/g or more. The composite magnetic particles included in the soft magnetic material of the present invention have a shape in which fine irregularities of the order of about 1/100 of the particle diameter are formed. These composite magnetic particles have projecting portions smaller than those of particles of known water-atomized powders. Accordingly, stress does not easily concentrate on the projecting portions and an insulating coating is not easily broken. As a result, eddy-current loss can be decreased. Furthermore, the composite magnetic particles included in the soft magnetic material of the present invention each have a large number of irregularities compared with known gas-atomized powders. Accordingly, the composite magnetic particles aggregate by means of these irregularities, thereby increasing the friction between the composite magnetic particles. As a result, the strength of the resulting compact can be improved.

In the soft magnetic material of the present invention, each of the plurality of composite magnetic particles preferably has an average particle diameter in the range of 10 to 500 μm.

When the average particle diameter of each of the plurality of composite magnetic particles is 5 μm or more, the metal is not easily oxidized, and thus a decrease in magnetic properties of the soft magnetic material can be suppressed. When the average particle diameter of each of the plurality of composite magnetic particles is 300 μm or less, a decrease in compressibility of a mixed powder can be suppressed during pressure molding. Consequently, the density of a compact produced by the pressure molding is not decreased, thus preventing difficulty in handling. In addition, from the viewpoint of magnetic properties, an average particle diameter of 5 μm or more is advantageous in that an increase in hysteresis loss due to the demagnetizing-field effect of a gap can be suppressed. An average particle diameter of 300 μm or less is also advantageous in that an increase in eddy-current loss due to the generation of eddy-current loss in the particle can be suppressed.

A dust core of the present invention is produced by using the above-described soft magnetic material. Accordingly, the strength of a compact can be improved while eddy-current loss is decreased.

### ADVANTAGES OF THE INVENTION

According to the soft magnetic material and the dust core of the present invention, eddy-current loss can be decreased.

### BRIEF DESCRIPTION OF THE DRAWINGS

FIG. 1 is an enlarged schematic view showing a dust core produced by using a soft magnetic material according to a first embodiment of the present invention.

FIG. 2 is a schematic view showing a single composite magnetic particle included in the soft magnetic material according to the first embodiment of the present invention.

FIG. 3 is a projection view showing a composite magnetic particle having a spherical shape.

FIG. 4 is a projection view showing a composite magnetic particle having a distorted shape.

FIG. 5 is an enlarged view of part III in FIG. 2.

FIG. 6 is a process drawing that sequentially shows the steps of a method of producing the dust core according to the first embodiment of the present invention.

FIG. 7 is a schematic view showing an aggregated state of composite magnetic particles composed of a water-atomized powder.

FIG. 8 is a schematic view showing an aggregated state of composite magnetic particles composed of a gas-atomized powder.

FIG. 9 is a schematic view showing an aggregated state of composite magnetic particles of the present invention.

### REFERENCE NUMERALS

10 metal magnetic particle
20 insulating coating
30, 130a, and 130b composite magnetic particle
31 irregularity
40 organic substance
131 projecting portion

### BEST MODE FOR CARRYING OUT THE INVENTION

An embodiment of the present invention will now be described with reference to the drawings.

### First Embodiment

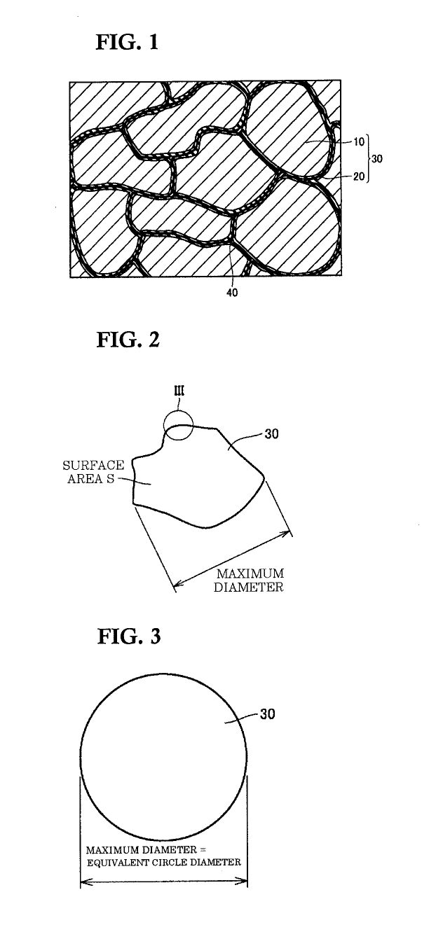

FIG. 1 is an enlarged schematic view showing a dust core produced by using a soft magnetic material according to a first embodiment of the present invention. As shown in FIG. 1, the dust core produced by using the soft magnetic material of this embodiment includes a plurality of composite magnetic particles 30 each composed of a metal magnetic particle 10 and an insulating coating 20 covering the surface of the metal magnetic particle 10. The plurality of composite magnetic particles 30 aggregate, for example, by means of an organic substance 40 disposed between the composite magnetic particles 30 or by means of engagement of irregularities that are present on the composite magnetic particles 30. Each of the plurality of composite magnetic particles 30 may further include a protective coating (not shown) covering the insulating coating 20. The organic substance 40 is not essential.

FIG. 2 is a plan view that schematically shows a single composite magnetic particle included in the soft magnetic material according to the first embodiment of the present invention. Referring to FIG. 2, the composite magnetic particle 30 of the soft magnetic material of the present invention has a ratio of the maximum diameter to the equivalent circle diameter of more than 1.0 and 1.3 or less and a specific surface area of 0.10 m²/g or more. The maximum diameter, the equivalent circle diameter and the specific surface area of the composite magnetic particle 30 are defined by the following methods.

Regarding the maximum diameter of the composite magnetic particle 30, the shape of the composite magnetic particle 30 is determined by an optical method (for example, observation with an optical microscope), and the maximum diameter is defined as the length of the part constituting the maximum particle diameter. Regarding the equivalent circle diameter of the composite magnetic particle 30, the shape of the composite magnetic particle 30 is determined by an optical method (for example, observation with an optical microscope), a surface area S of the composite magnetic particle 30 when viewed two-dimensionally is measured, and the equivalent circle diameter is calculated using Eq. (1):

Equivalent circle diameter=2×{surface area S/π}^{1/2} (1)

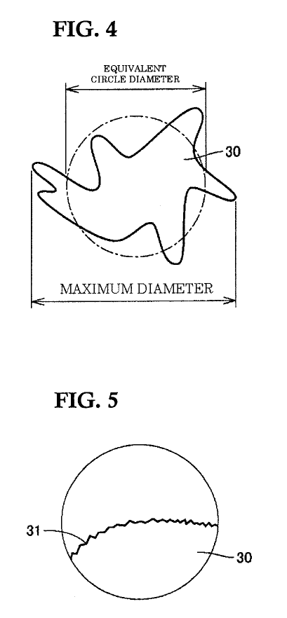

That is, as shown in FIG. 3, when a composite magnetic particle has a spherical shape, the ratio of the maximum diameter to the equivalent circle diameter is 1. As shown in FIG. 4, when a composite magnetic particle has larger projecting portions, the above ratio becomes higher. The specific surface area of the composite magnetic particle 30 is measured by a BET method. More specifically, an inert gas whose adsorption occupancy area is known is adsorbed on the surfaces of composite magnetic particles at the temperature of liquid nitrogen. The specific surface area of the composite magnetic particles is determined from the amount of adsorption.

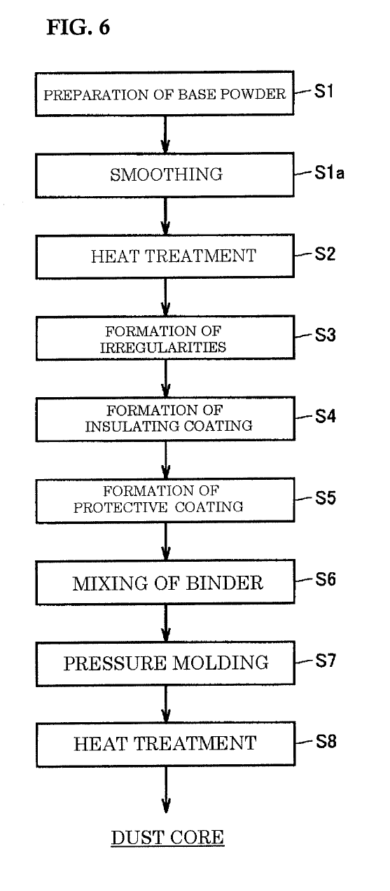

FIG. 5 is an enlarged view of part III in FIG. 2. Referring to FIG. 5, when the ratio of the maximum diameter to the equivalent circle diameter of each of the composite magnetic particles 30 is within the above range, a large number of fine irregularities 31 of the order of about 1/100 of the particle diameter are formed on the surface of the composite magnetic particle 30. The composite magnetic particles 30 aggregate by means of engagement of these irregularities 31.

Referring to FIGS. 1 and 2, the average particle diameter of the composite magnetic particles 30 is preferably in the range of 5 to 300 μm. When the average particle diameter of the composite magnetic particles 30 is 5 μM or more, the metal is not easily oxidized, and thus a decrease in magnetic properties of the soft magnetic material can be suppressed. When the average particle diameter of the composite magnetic particles 30 is 300 μm or less, a decrease in compressibility of a mixed powder can be suppressed during pressure molding. Consequently, the density of a compact produced by the pressure molding is not decreased, thus preventing difficulty in handling.

The average particle diameter mentioned here means a particle diameter of a particle at which the cumulative sum of the masses of particles determined by adding the masses of particles starting from the smallest particle diameter reaches 50% in a histogram of particle diameters measured by means of a sieve method, that is, a 50% cumulative mass average particle diameter D.

The metal magnetic particles 10 are made of, for example, Fe, an Fe—Si alloy, an Fe—N (nitrogen) alloy, an Fe—Ni (nickel) alloy, an Fe—C (carbon) alloy, an Fe—B (boron) alloy, an Fe—Co (cobalt) alloy, an Fe—P alloy, an Fe—Ni—Co alloy, an Fe—Cr (chromium) alloy, or an Fe—Al—Si alloy. The metal magnetic particles 10 may be made of a metal element or an alloy as long as the metal magnetic particles 10 contain Fe as a main component.

The insulating coating 20 functions as an insulating layer disposed between the metal magnetic particles 10. By coating the metal magnetic particles 10 with the insulating coating 20, the electrical resistivity p of a dust core produced by molding the resulting soft magnetic material under pressure can be increased. Accordingly, the flow of eddy currents between the metal magnetic particles 10 can be suppressed, thereby reducing eddy-current loss the dust core. The insulating coating 20 is made of an insulating substance such as a metal oxide, a metal nitride, a metal carbide, a metal phosphate compound, a metal borate compound, or a metal silicate compound each containing Fe, Al, Ca, Mn, Zn, Mg, V, Cr, Y, Ba, Sr, or a rare earth element as a metal.

The thickness of the insulating coating 20 is preferably in the range of 0.005 to 20 μm. When the thickness of the insulating coating 20 is 0.005 μm or more, the generation of a tunneling current can be prevented, and energy loss due to an eddy current can be effectively suppressed. When the thickness of the insulating coating 20 is 20 μm or less, the ratio of the insulating coating 20 to the soft magnetic material is not excessively high, thus preventing a marked decrease in the magnetic flux density of a dust core produced by molding the resulting soft magnetic material under pressure.

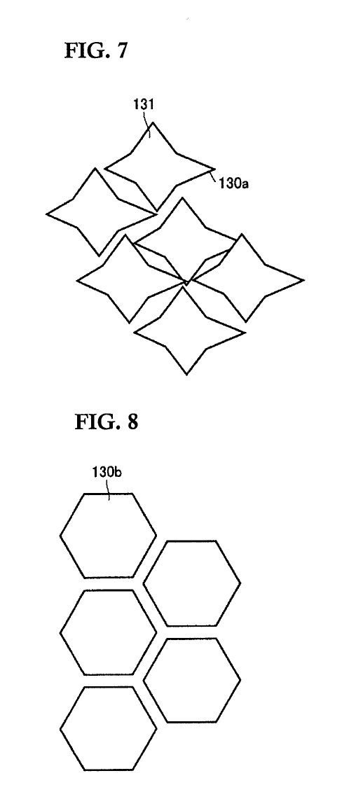

A method of producing the dust core shown in FIG. 1 will now be described. FIG. 6 is a process drawing that sequentially shows the steps of the method of producing the dust core according to the first embodiment of the present invention.

Referring to FIG. 6, first, a base powder composed of metal magnetic particles 10 that contain Fe as a main component and that are made of, for example, pure iron having a purity of 99.8% or more, Fe, an Fe—Si alloy, or an Fe—Co alloy is prepared (step S1). In this step, when the average particle diameter of the metal magnetic particles 10 is in the range of 5 to 300 μm, the average particle diameter of the composite magnetic particles 30 of the produced soft magnetic material can be in the range of 5 to 300 μm. This is because the thickness of the insulating coating 20 is negligible compared with the particle diameter of each of the metal magnetic particles 10, and the particle diameter of each of the composite magnetic particles 30 and the particle diameter of each of the corresponding metal magnetic particles 10 are substantially the same.

The metal magnetic particles 10 may be a gas-atomized powder or a water-atomized powder. Here, the gas-atomized powder is a powder produced by atomizing a molten metal of a material to be formed into metal magnetic particles with a high-pressure gas, and then rapidly cooling with a gas. The water-atomized powder is a powder produced by atomizing a molten metal of a material to be formed into metal magnetic particles into water with a high-pressure water stream.

When the metal magnetic particles 10 are composed of a water-atomized powder, a large number of projecting portions are present on the surfaces of the metal magnetic particles 10. Therefore, in order to remove the projecting portions, the surface layer of the metal magnetic particles 10 is made smooth (step Sla). More specifically, the surface of the soft magnetic material is worn out with a ball mill to remove the projecting portions on the surfaces of the metal magnetic particles 10. As the processing time with the ball mill increases, the projecting portions are removed to a greater extent and the shape of the metal magnetic particles 10 becomes closer to being spherical. When the processing time with the ball mill is, for example, in the range of 30 to 60 minutes, metal magnetic particles 10 having a ratio of the maximum diameter to the equivalent circle diameter of more than 1.0 and 1.3 or less can be obtained.

When the metal magnetic particles 10 are composed of a gas-atomized powder, each of the metal magnetic particles 10 originally has a substantially spherical shape and has a ratio of the maximum diameter to the equivalent circle diameter of more than 1.0 and 1.3 or less. Accordingly, this spheroidizing treatment may be omitted.

Subsequently, the metal magnetic particles 10 are heat-treated at a temperature of 400° C. or higher and lower than the melting point of the particles (step S2). A large number of distortions (dislocations and defects) are present inside the metal magnetic particles 10 before heat treatment. Accordingly, by heat-treating the metal magnetic particles 10, these distortions can be reduced. The temperature of the heat treatment is more preferably 700° C. or higher and lower than 900° C. When the heat treatment is performed in this temperature range, a satisfactory effect of removing the distortions can be obtained while sintering between the particles can be prevented. This heat treatment may be omitted.

Subsequently, irregularities are formed on the surfaces of the metal magnetic particles 10 (step S3). More specifically, the metal magnetic particles 10 are immersed in an aqueous sulfuric acid solution having a predetermined concentration. Accordingly, the surfaces of the metal magnetic particles 10 are etched by sulfuric acid, and irregularities are formed on the surfaces of the metal magnetic particles 10. By controlling the immersion time in the aqueous sulfuric acid solution, the amount and the shape of the irregularities formed on the surfaces of the metal magnetic particles 10 can be controlled. When the immersion time in the aqueous sulfuric acid solution is, for example, 20 minutes or more, the specific surface area of the metal magnetic particles 10 becomes 0.10 m²/g or more.

Subsequently, an insulating coating 20 is formed on the surfaces of the metal magnetic particles 10 by immersing the metal magnetic particles 10 in, for example, an aqueous aluminum phosphate solution (step S4).

Subsequently, a protective coating made of, for example, a silicone resin is formed (step S5). More specifically, a silicone resin dissolved in an organic solvent is mixed with or atomized on the metal magnetic particles 10 coated with the insulating coating 20. The metal magnetic particles 10 are then dried to remove the solvent. The formation of this protective coating may be omitted.

By performing the above-described steps, the soft magnetic material of this embodiment is produced. Furthermore, by performing the following production steps, the dust core of this embodiment is produced.

Subsequently, the resulting composite magnetic particles 30 are mixed with an organic substance 40 used as a binder (step S6). The mixing method is not particularly limited. For example, a dry mixing using a V-type mixer or a wet mixing using a mixer-type blending machine may be employed. Consequently, the plurality of composite magnetic particles 30 are aggregated by the presence of the organic substance 40. This mixing with a binder may be omitted.

Examples of the organic substance 40 include thermoplastic resins such as thermoplastic polyimides, thermoplastic polyamides, thermoplastic polyamideimides, polyphenylene sulfides, polyamideimides, polyethersulfones, polyetherimides, and polyetheretherketones; non-thermoplastic resins such as high-molecular-weight polyethylenes, fully aromatic polyesters, and fully aromatic polyimides; and higher fatty acids such as zinc stearate, lithium stearate, calcium stearate, lithium palmitate, calcium palmitate, lithium oleate, and calcium oleate. These may be used in combinations.

Subsequently, the powder of the resulting soft magnetic material is supplied in a die and molded under a pressure, for example, in the range of 390 to 1,500 (MPa) (step S7). Accordingly, a compact in which the powder composed of the metal magnetic particles 10 is compressed is prepared. The atmosphere during the pressure molding is preferably an inert gas atmosphere or a reduced pressure atmosphere. In this case, oxidation of the mixed powder by oxygen in air can be suppressed.

Subsequently, the compact prepared by the pressure molding is heat-treated at a temperature in the range of 200° C. to 900° C. (step S8). Since a large number of distortions and dislocations are generated inside the compact formed by pressure molding, the distortions and dislocations can be removed by the heat treatment. By performing the above-described steps, the dust core shown in FIG. 1 is produced.

According to the soft magnetic material and the dust core of this embodiment, the strength of a compact can be improved while eddy-current loss is decreased. The reason for this will now be described.

FIG. 7 is a schematic view showing an aggregated state of composite magnetic particles composed of a water-atomized powder. Referring to FIG. 7, composite magnetic particles 130a produced from a water-atomized powder each include a large number of projecting portions 131. Accordingly, since the composite magnetic particles 130a are engaged with each other by the projecting portions, aggregation between the composite magnetic particles 130a can be enhanced to improve the strength of the resulting compact. However, in the composite magnetic particles 130a, stress is concentrated on the projecting portions during pressure molding, thereby breaking an insulating coating. As a result, eddy-current loss is increased.

FIG. 8 is a schematic view showing an aggregated state of composite magnetic particles composed of a gas-atomized powder. Referring to FIG. 8, composite magnetic particles 130b produced from a gas-atomized powder include little projecting portions. Accordingly, in the composite magnetic particles 130b, the breakage of an insulating coating can be prevented during pressure molding, and thus eddy-current loss can be decreased. However, since the composite magnetic particles 130b do not have projecting portions, aggregation between the composite magnetic particles 130b is decreased, resulting in a decrease in the strength of the resulting compact.

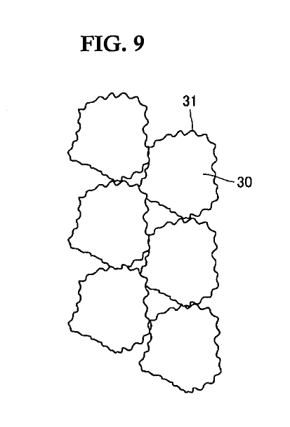

As shown in FIGS. 7 and 8, in composite magnetic particles obtained from known water-atomized powders or gas-atomized powders, the strength of a compact cannot be increased while eddy-current loss is decreased. In contrast, as shown in FIG. 9, the composite magnetic particles 30 included in the soft magnetic material of the present invention have a shape in which a large number of fine irregularities 31 of the order of about 1/100 of the particle diameter are formed. Accordingly, aggregation between the composite magnetic particles 30 can be enhanced by the large number of irregularities 31, thereby improving the strength of the resulting compact. The projections of the irregularities 31 of the composite magnetic particles 30 are smaller than the projecting portions 131 of the composite magnetic particles 130a composed of a water-atomized powder. Therefore, the breakage of an insulating coating can be suppressed during pressure molding, and thus eddy-current loss can be decreased.

Furthermore, since the insulating coating of the composite magnetic particles 30 included in the soft magnetic material of the present invention is not easily broken during pressure molding compared with that of composite magnetic particles obtained from known water-atomized powders or gas-atomized powders, even when the heat treatment after pressure molding is performed at a high temperature (for example, a temperature higher than 500° C.), the breakage of the insulating coating due to heat does not easily occur. Accordingly, distortions in the metal magnetic particles can be efficiently removed while an increase in eddy-current loss is suppressed. Thus, both hysteresis loss and eddy-current loss of the soft magnetic material can be decreased.

### Example 1

In this example, soft magnetic materials of samples A1 to A13 and samples B1 to B13 were prepared using substantially the same production method as that described in the first embodiment. The ratio of the maximum diameter to the equivalent circle diameter (maximum diameter/equivalent circle diameter) and the specific surface area (m²/g) of composite magnetic particles of the soft magnetic materials were examined.

First, a water-atomized powder (samples A1 to A12 and samples B1 to B12) and a gas-atomized powder (samples A13 and B13) each having a particle diameter in the range of 50 to 150 μm and a purity of 99.8% or more were prepared as metal magnetic particles. The metal magnetic particles composed of the water-atomized powder were then spheroidized with a ball mill A planetary ball mill P-5 manufactured by Fritsch GmbH was used for the ball mill processing. A plurality types of metal magnetic particles in which a processing condition for the ball mill was different were prepared by changing the ball mill processing time in the range of 1 to 60 minutes. For comparison, metal magnetic particles that were not subjected to the ball mill processing were also prepared. The metal magnetic particles composed of the gas-atomized powder were not spheroidized. The metal magnetic particles for each sample were then heat-treated at 600° C. in a hydrogen stream.

Subsequently, the metal magnetic particles 10 to be formed into samples B1 to B13 were immersed in an aqueous sulfuric acid solution for 20 minutes to form irregularities on the surfaces of the metal magnetic particles. The aqueous sulfuric acid solution used was prepared by dissolving 0.75 g of H₂SO₄ in 1 L of water relative to 1 kg of the metal magnetic particles and adjusting the pH of the aqueous solution to about 2.0. In contrast, the above treatment with the aqueous sulfuric acid solution was not performed in samples A1 to A13.

Subsequently, the metal magnetic particles for each sample were immersed in an aqueous solution of a phosphate to form an insulating coating. The metal magnetic particles coated with the insulating coating were then mixed with a silicone resin (trade name “TSR116”, manufactured by GE Toshiba Silicones Co., Ltd.). The silicone resin was then thermally cured by heating the mixture in air at 150° C. for one hour to form a protective coating. Thus, soft magnetic materials were prepared.

The ratio of the maximum diameter to the equivalent circle diameter (maximum diameter/equivalent circle diameter) and the specific surface area (m²/g) of the composite magnetic particles were measured using the soft magnetic materials thus prepared. The results are shown in Table I.

TABLE I

| | | | Ball mill | Maximum | | |
|---|---|---|---|---|---|---|
| | | Treatment with aqueous | processing | diameter/equivalent | Specific surface | |
| Sample | Powder | sulfuric acid solution | time (min) | circle diameter | area (m²/g) | Determination |
| Sample A1 | Water-atomized powder | A treatment with an | 0 | 1.54 | 2.7E−02 | Comparative |
| Sample A2 | (50 to 150 μm) | aqueous sulfuric acid | 1 | 1.52 | 2.8E−02 | sample |
| Sample A3 | | solution was not | 3 | 1.49 | 2.8E−02 | |
| Sample A4 | | performed. | 5 | 1.46 | 2.6E−02 | |
| Sample A5 | | | 7 | 1.42 | 2.6E−02 | |
| Sample A6 | | | 10 | 1.38 | 2.4E−02 | |
| Sample A7 | | | 15 | 1.33 | 2.1E−02 | |
| Sample A8 | | | 20 | 1.31 | 2.2E−02 | |
| Sample A9 | | | 30 | 1.27 | 2.0E−02 | |
| Sample A10 | | | 40 | 1.26 | 1.9E−02 | |
| Sample A11 | | | 50 | 1.25 | 1.9E−02 | |
| Sample A12 | | | 60 | 1.24 | 1.8E−02 | |
| Sample A13 | Gas-atomized powder | | — | 1.08 | 1.2E−02 | |
| | (50 to 150 μm) | | | | | |
| Sample B1 | Water-atomized powder | A treatment with an | 0 | 1.54 | 2.2E−01 | |
| Sample B2 | (50 to 150 μm) | aqueous sulfuric acid | 1 | 1.52 | 2.2E−01 | |
| Sample B3 | | solution was performed. | 3 | 1.49 | 2.2E−01 | |
| Sample B4 | | | 5 | 1.46 | 2.1E−01 | |
| Sample B5 | | | 7 | 1.42 | 2.1E−01 | |
| Sample B6 | | | 10 | 1.38 | 2.0E−01 | |
| Sample B7 | | | 15 | 1.33 | 2.0E−01 | |
| Sample B8 | | | 20 | 1.31 | 1.7E−01 | |
| Sample B9 | | | 30 | 1.27 | 1.8E−01 | Sample of the |
| Sample B10 | | | 40 | 1.26 | 1.6E−01 | present |
| Sample B11 | | | 50 | 1.25 | 1.6E−01 | invention |
| Sample B12 | | | 60 | 1.24 | 1.6E−01 | |
| Sample B13 | Gas-atomized powder | | — | 1.08 | 1.1E−01 | |
| | (50 to 150 μm) | | | | | |

Referring to Table I, when samples B1 to B13 were compared with each other, as the processing time with the ball mill increased, the ratio of the maximum diameter to the equivalent circle diameter of the composite magnetic particles was close to 1. This also applied to samples A1 to A13. In particular, in samples A9 to A13 and samples B9 to B13, the ratios of the maximum diameter to the equivalent circle diameter of the composite magnetic particles were more than 1.0 and 1.3 or less. These results showed that, as the processing time with the ball mill increased, the projecting portions were removed to a greater extent and the shapes of the composite magnetic particles became closer to being spherical. When the gas-atomized powder was used, the ratio of the maximum diameter to the equivalent circle diameter of the composite magnetic particles was 1.08, which showed that the shapes of the composite magnetic particles were the closest to being spherical.

Comparing samples A1 to A13 with samples B1 to B13, respectively, in the case where the processing time with the ball mill was the same, there was no difference in the ratio of the maximum diameter to the equivalent circle diameter of the composite magnetic particles. These results showed that the treatment with an aqueous sulfuric acid solution did not affect the ratio of the maximum diameter to the equivalent circle diameter of the composite magnetic particles.

Comparing samples A1 to A13 with samples B1 to B13, respectively, in the case where the processing time with the ball mill was the same, the specific surface areas of samples B1 to B13 were larger than those of samples A1 to A13, respectively. In particular, in samples B1 to B13, the specific surface areas of the composite magnetic particles were 0.10 m²/g or more. These results showed that irregularities were formed on the surfaces of the metal magnetic particles by treating with the aqueous sulfuric acid solution, and the specific surface areas of the composite magnetic particles were increased.

Among samples A1 to A13 and samples B1 to B13, samples that satisfied a ratio of the maximum diameter to the equivalent circle diameter of the composite magnetic particles of more than 1.0 and 1.3 or less and a specific surface area of 0.10 m²/g or more were only samples B9 to B13. Accordingly, samples B9 to B13 corresponded to samples of the present invention.

### Example 2

In this example, dust cores were prepared using samples A1 to A13 and samples B1 to B13 prepared in Example 1 and magnetic properties of the dust cores were evaluated.

Each of the soft magnetic materials prepared in Example 1 was molded under a surface pressure in the range of 10 to 13 ton/cm² to prepare a ring-shaped compact (outer diameter: 34 mm, inner diameter 20 mm, thickness: 5 mm) having a density of 7.60 g/cm³. The compact was then heat-treated in a nitrogen stream atmosphere at 500° C. for one hour. As regards samples A6 to A13 and samples B8 to B13, even when the compacts were heat-treated at a temperature higher than 500° C., the insulating coating was not broken. Therefore, heat treatment was also performed at an optimum temperature exceeding 500° C. Thus, dust cores were prepared.

Hysteresis loss, eddy-current loss, and core loss of the dust cores prepared above were measured with a BH curve tracer. In the measurement, the excitation magnetic flux density was 10 kG (=1 T (tesla)) and the measurement frequency was in the range of 50 Hz to 1 kHz. The hysteresis loss and the eddy-current loss were separated as follows. The frequency curve of the core loss was fitted by a least squares method using the following three equations to calculate a hysteresis loss coefficient and an eddy-current loss coefficient. The results are shown in Table II.

(Core loss)=(hysteresis loss coefficient)×(frequency)+(eddy-current loss coefficient)×(frequency)²

(Hysteresis loss)=(hysteresis loss coefficient)×(frequency)

(Eddy-current loss)=(eddy-current loss coefficient)×(frequency)²

TABLE II

| | | | | | Magnetic properties of | | | | |
|---|---|---|---|---|---|---|---|---|---|
| | | Magnetic properties of | | | compact treated at optimum | | | | |
| | | compact treated at | | | temperature | | | | |
| | | 500° C. | | | Optimum | Hysteresis | Eddy- | Core | Flexural strength: |
| | | Hysteresis loss | Eddy-current | Core loss | treatment | loss | current loss | loss | σ3b (MPa) |
| | | Wh10/1k | loss We10/1k | W10/1k | temperature | Wh10/1k | We10/1k | W10/1k | Strength of compact |
| Sample | | (W/kg) | (W/kg) | (W/kg) | (° C.) | (W/kg) | (W/kg) | (W/kg) | (annealed at 500° C.) |
| Comparative | Sample A1 | 126 | 21 | 147 | 500 | — | — | — | 109 |
| sample | Sample A2 | 128 | 20 | 148 | 500 | — | — | — | 104 |
| | Sample A3 | 125 | 19 | 144 | 500 | — | — | — | 94 |
| | Sample A4 | 118 | 19 | 137 | 500 | — | — | — | 88 |
| | Sample A5 | 121 | 18 | 139 | 500 | — | — | — | 82 |
| | Sample A6 | 120 | 17 | 137 | 520 | 108 | 22 | 130 | 80 |
| | Sample A7 | 116 | 15 | 131 | 520 | 102 | 19 | 121 | 63 |
| | Sample A8 | 108 | 14 | 122 | 560 | 75 | 23 | 98 | 66 |
| | Sample A9 | 109 | 13 | 122 | 560 | 73 | 26 | 99 | 53 |
| | Sample A10 | 104 | 13 | 117 | 560 | 75 | 24 | 99 | 43 |
| | Sample A11 | 106 | 13 | 119 | 560 | 71 | 27 | 98 | 44 |
| | Sample A12 | 106 | 13 | 119 | 580 | 66 | 26 | 92 | 38 |
| | Sample A13 | 82 | 24 | 106 | 600 | 52 | 31 | 83 | 26 |
| | Sample B1 | 126 | 18 | 144 | 500 | — | — | — | 132 |
| | Sample B2 | 130 | 18 | 148 | 500 | — | — | — | 139 |
| | Sample B3 | 125 | 17 | 142 | 500 | — | — | — | 133 |
| | Sample B4 | 120 | 17 | 137 | 500 | — | — | — | 125 |
| | Sample B5 | 126 | 17 | 143 | 500 | — | — | — | 120 |
| | Sample B6 | 121 | 15 | 136 | 500 | — | — | — | 121 |
| | Sample B7 | 113 | 14 | 127 | 500 | — | — | — | 118 |
| | Sample B8 | 110 | 14 | 124 | 520 | 93 | 30 | 123 | 102 |
| Sample of the | Sample B9 | 108 | 11 | 119 | 540 | 79 | 29 | 108 | 96 |
| present | Sample B10 | 98 | 11 | 109 | 560 | 64 | 33 | 97 | 92 |
| invention | Sample B11 | 100 | 9 | 109 | 560 | 60 | 32 | 92 | 93 |
| | Sample B12 | 103 | 10 | 113 | 560 | 63 | 28 | 91 | 89 |
| | Sample B13 | 85 | 18 | 103 | 600 | 52 | 33 | 85 | 72 |

Referring to Table II, when samples B1 to B13 are compared, as the ratio of the maximum diameter to the equivalent circle diameter of the composite magnetic particles was close to 1, hysteresis loss, eddy-current loss, and core loss were substantially decreased. This also applied to samples A1 to A13. In particular, in samples B9 to B12, eddy-current loss was very low; 11 or less. These results showed that, according to the soft magnetic material of the present invention, the breakage of an insulating coating during pressure molding could be suppressed, and magnetic properties such as eddy-current loss could be improved.

In samples A6 to A13 and samples B8 to B13, a heat treatment of the compact could be performed at a temperature higher than 500° C. As a result, hysteresis loss was markedly decreased. For example, in sample B10, when the heat treatment was performed at 500° C., the hysteresis loss was 98 W/kg. In contrast, when the heat treatment was performed at 560° C., the hysteresis loss was markedly decreased to 64 W/kg. It is believed that the reason for this is as follows. In samples A6 to A13 and samples B8 to B13, since the shapes of the metal magnetic particles become closer to being spherical, the insulating coating is not broken even when the compacts are heat-treated at a temperature exceeding 500° C. Accordingly, even when the heat treatment is performed after pressure molding at a high temperature, the insulating coating is not broken. Thus, distortions in the metal magnetic particles can be effectively removed while an increase in the eddy-current loss is suppressed. As a result, hysteresis loss of the soft magnetic materials can be markedly decreased.

In samples A9 to A13 and samples B9 to B13, when the strengths of compacts of samples having the same ratio of the maximum diameter to the equivalent circle diameter of the composite magnetic particles (samples having the same reference number) were compared, for example, the strength of the compact of sample A9 was 53 MPa, whereas that of sample B9 was 96 MPa. Similarly, the strength of the compact of sample A10 was 43 MPa, whereas that of sample B10 was 92 MPa. The strength of the compact of sample A11 was 44 MPa, whereas that of sample B11 was 93 MPa. The strength of the compact of sample A12 was 38 MPa, whereas that of sample B12 was 89 MPa. Furthermore, the strength of the compact of sample A13 was 26 MPa, whereas that of sample B13 was 72 MPa. These results showed that the soft magnetic materials of the present invention could improve the strengths of the resulting compacts.

It should be understood that the embodiments and examples disclosed herein are illustrative in all points and not restrictive. The scope of the present invention is defined by the claims rather than by the description preceding them; it is intended to include all variations falling within the meaning and scope equivalent to the scope of the claims.

### INDUSTRIAL APPLICABILITY

A soft magnetic material and a dust core of the present invention are generally used for, for example, a motor core, a solenoid valve, a reactor, and an electromagnetic component.

1-3. (canceled)

4. A method of producing a soft magnetic material, comprising:
forming a plurality of metal magnetic particles having a ratio of a maximum diameter to an equivalent circle diameter greater than 1.0 and at most 1.3;
forming irregularities on a surface of each of the plurality of metal magnetic particles such that a specific surface area of each of the plurality of metal magnetic particles is at least 0.10 m²/g; and
coating the plurality of metal magnetic particles with an insulating coating;
wherein the step of forming irregularities comprises immersing the plurality of metal magnetic particles in an aqueous sulfuric acid.
